(19) United States
(12) Patent Application Publication
(10) Pub. No.: US 2007/0024585 A1
(43) Pub. Date: Feb. 1, 2007

(54) Input device capable of transmitting data utilizing wired or wireless transission manners

(75) Inventors: Chih-Sheng Tsai, Taipei City (TW); Lun-Wei Kang, Taipei City (TW)

Correspondence Address: BIRCH, STEWART, KOLASCH & BIRCH, LLP, 8110 GATEHOUSE ROAD, SUITE 100 EAST, FALLS CHURCH, VA, 22315, US

(73) Assignee: ASUSTek COMPUTER INC.

(21) Appl. No.: 11/493,757

(22) Filed: Jul. 27, 2006

(30) Foreign Application Priority Data
Jul. 28, 2005 (TW) 094125569

(51) Int. Cl. G09G 5/08

(52) U.S. Cl. 345/163; 345/156

(57) ABSTRACT

The invention relates to an input device capable of transmitting data according to a wired transmission manner or a wireless transmission manner. The input device includes a receiver and an input module. The receiver is connected to a computer for transmitting a first data to the computer, and includes a first connector and a first wireless transceiving module. The input module includes a signal generating module for generating the first data, a second connector, and a second wireless transceiving module. The input module transmits the first data to the receiver through the first and the second connectors by utilizing the wired transmission manner, or through the first and the second wireless transceiving modules by utilizing the wireless transmission manner.

### BACKGROUND OF THE INVENTION

1. Field of the Invention

The present invention relates to an input device, and more specifically, to an input device capable of transmitting data utilizing a wired transmission manner or a wireless transmission manner.

2. Description of the Prior Art

When a user utilizes a wired mouse to control a computer, the user usually needs to sit in front of, or close to the computer because the range of the wired mouse is limited by the length of a transmission line of the wired mouse. In contrast to the wired mouse, the range of a wireless mouse is not limited by a transmission line, so the user can control the computer from a more distant location. In other words, the utilization of a wireless mouse is more flexible than that of a wired mouse.

The above-mentioned wireless mouse has several limitations, however. A major disadvantage of the wireless mouse is that the wireless mouse module is battery-powered, meaning a user has to regularly purchase new batteries. The user can use rechargeable batteries to save expense and avoid producing garbage. However, the rechargeable batteries must be regularly re-charged when they run out of power, which is very inconvenient.

### SUMMARY OF THE INVENTION

One of the objectives of the claimed invention is therefore to provide an input device capable of transmitting data utilizing a wired transmission manner or a wireless transmission manner, in order to solve the above-mentioned problem.

According to the claimed invention, an input device capable of transmitting data according to a wired transmission manner or a wireless transmission manner is disclosed. The input device comprises: a receiver connected to a computer for transmitting a first data to the computer, and an input module. The receiver comprises a first connector and a first wireless transceiving module. The input module comprises: a signal generating module for generating the first data; a second connector electrically connected to the signal generating module, wherein the input module transmits the first data to the receiver through the first and the second connectors by utilizing the wired transmission manner when the second connector is electrically connected to the first connector; and a second wireless transceiving module electrically connected to the signal generating module, wherein the input module transmits the first data to the receiver through the first and the second wireless transceiving modules by utilizing the wireless transmission manner when the second connector is not electrically connected to the first connector.

The input device according to the present invention comprises a pair of wireless transceiving modules and a pair of connectors. The above-mentioned input device can determine to transmit data according to a wired transmission manner or a wireless transmission manner, according to user requirements, the power supply situation or other considerations of the working environment.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is an external view diagram of a preferred embodiment of an input device capable of transmitting data according to a wired transmission manner or a wireless transmission manner.

FIG. 2 is a functional block diagram of the input module shown in FIG. 1.

FIG. 3 is a functional block diagram of the receiver shown in FIG. 1.

FIG. 4 is an operational diagram of the input device shown in FIG. 1.

### DETAILED DESCRIPTION

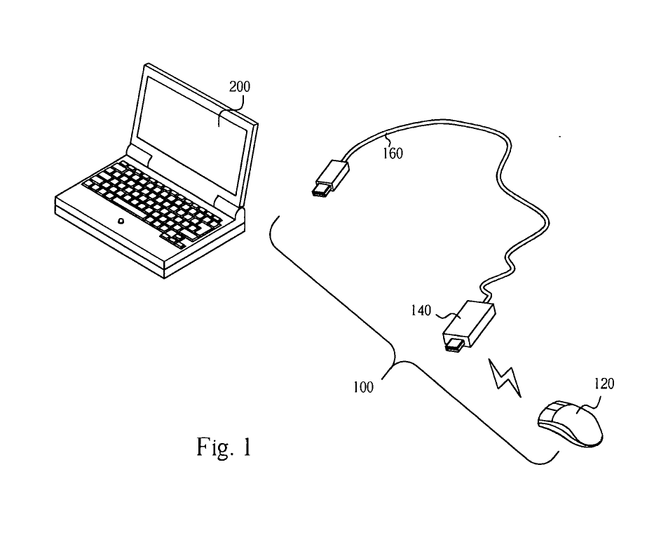

Please refer to FIG. 1. FIG. 1 is an external view diagram of a preferred embodiment of an input device 100 capable of transmitting data according to a wired transmission manner or a wireless transmission manner. As shown in FIG. 1, the input device 100 comprises an input module 120, a receiver 140 and a transmission line 160. In the present embodiment, the input module 120 is a mouse, and the transmission line 160 is a universal serial bus (USB) transmission line for transmitting data between the receiver 140 and the computer 200. Please note that according to the claims of the present invention, the input module 120 can also be a writing tablet or a keyboard and is not limited to the present embodiment.

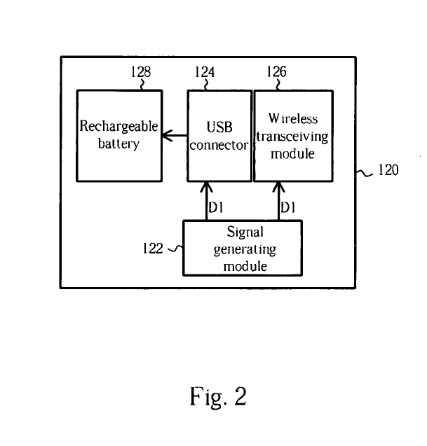

Please refer to FIG. 2. FIG. 2 is a functional block diagram of the input module 120 shown in FIG. 1. As shown in FIG. 1, the input module 120 comprises a signal generating module 122, a USB connector 124, a wireless transceiving module 126 and a rechargeable battery 128. In the present embodiment, the main function of the signal generating module 122 is to generate a data D1 according to an acceleration generated when the input module 120 moves, and transmit the data D1 through the wireless transceiving module 126 or the USB connector 124 to the computer 200 to control the computer 200 shown in FIG. 1. The operation of generating the data D1 is well known in the art and is not included in the following paragraphs for brevity. In addition, another function of the signal generating module 122 is to decide to transmit the data D1 to the USB connector 124 or to the wireless transceiving module 126. If the signal generating module 122 has detected that the USB connector 124 is electrically connected to the receiver 140 shown in FIG. 1, the signal generating module 122 transmits the D1 to the USB connector 124. At this time, the input module 120 decides to transmit data according to the wired transmission manner. On the other hand, if the signal generating module 122 detects that the USB connector 124 is not electrically connected to the receiver 140 shown in FIG. 1, the signal generating module 122 transmits the data D1 to the wireless transceiving module 126. At this time, the input module 120 decides to transmit data according to the wireless transmission manner. In addition, the rechargeable battery 128 is utilized for storing power and providing an operation voltage required by the input module 120.

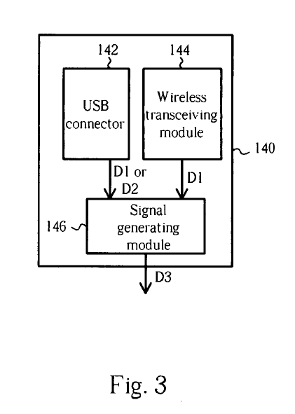

Please refer to FIG. 3. FIG. 3 is a functional block diagram of the receiver 140 shown in FIG. 1. In the present embodiment, the receiver 140 comprises a USB connector 142, a wireless transceiving module 144 and a signal integrating module 146. The USB connector 142 is connected to the USB connector 124 shown in FIG. 2 for receiving the data D1. In this way, if the USB connector 124 shown in FIG. 2 is a male connector, then the USB connector 142 is a female connector; on the other hand, if the USB connector 124 shown in FIG. 2 is a female connector, then the USB connector 142 is a male connector. The wireless transceiving module 144 is utilized for receiving data transmitted by the wireless transceiving module 126 shown in FIG. 2. Additionally, the signal integrating module 146 according to the present invention can be replaced with a switching circuit. In this way, either the USB connector 142 or the wireless transceiving module 144 can transmit data to the computer through the above-mentioned switching circuit. When the wireless transceiving module 144 is enabled, the receiver 140 cannot receive any data through the USB connector 142. In the same manner, when the receiver 140 receives data through the USB connector 142, the wireless transceiving module 144 is disabled. However, the integration module 146 according to the present invention can simultaneously receive data transmitted by the wireless transceiving module 144 and the USB connector 142 and then integrate them.

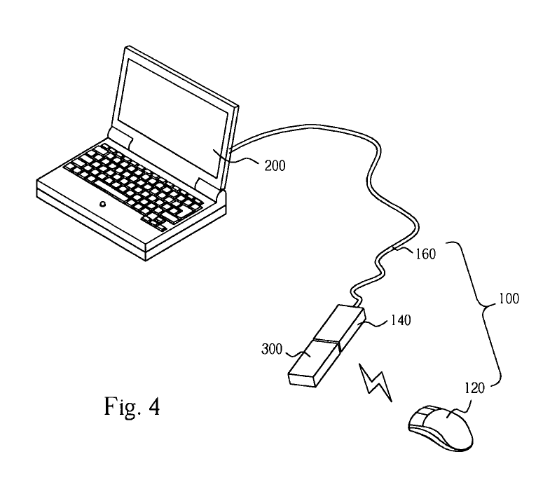

Please refer to FIG. 3 and FIG. 4 for a detailed description of the receiver 140 and the integration module 146. FIG. 4 is an operational diagram of the input device 100 shown in FIG. 1. As shown in FIG. 4, the transmission line 160 is connected to the computer 200. The input module 120 performs the data transmission with the receiver 140 according to the wireless transmission manner. In addition, an external device 300, such as a USB flash disk, is plugged into the receiver 140. Under such an operation, the USB connector 142 receives the data D2 transmitted by the external device 300, and the wireless transceiving module 144 receives the data D1 transmitted by the wireless transceiving module 126 shown in FIG. 2. Next, the signal integrating module 146 integrates the data D1 and D2 to generate an integration data D3, and then transmits the integration data D3 to the computer. Please note that the external device 300 is not a part of the input device 100. When the input module 120 transmits the data D1 according to the wireless transmission manner, in addition to being capable of receiving the data D1, the receiver 140 is further utilized as a USB extended line of the external device 300.

Please refer to FIG. 1 and FIG. 2. The rechargeable battery 128 is utilized for providing the operation voltage required by the input module 120. When the power stored in the rechargeable battery 128 is not sufficient for utilization, a user can connect the input module 120 to the receiver 140, which means the user connects the USB connector 142 to the USB connector 124 shown in FIG. 3. In this way, the computer 200 provides the receiver 140 and the input module 120 with power through its own USB port, and the rechargeable battery 128 can be charged through the USB connectors 124 and 142. In this case, the user can utilize the input device 100 as a wired mouse and the rechargeable battery 128 can be charged at the same time. When the power stored in the rechargeable battery 128 is sufficient for utilization, the user can utilize the input device 100 as a wireless mouse.

Please note that according to the claims of the invention, the above-mentioned connectors and a transmission interface utilized by the transmission line is not limited to the USB interface. Other data transmission interfaces capable of transmitting power can be utilized as the above-mentioned transmission interface; for example, FireWire also can be applied in the connectors and the transmission line of the present invention. Additionally, the above-mentioned rechargeable batteries can be replaced with any rechargeable battery modules.

In contrast to the related art, the input device according to the present invention can decide to transmit data according to a wired transmission manner or a wireless transmission manner. The input device comprises a built-in rechargeable battery. When the power stored in the rechargeable battery is not sufficient for utilization, the user can utilize the above-mentioned input device as a wired mouse and the rechargeable battery can be charged at the same time. When the power of the rechargeable battery is sufficient for utilization, the user can utilize the input device as a wireless mouse. In addition, when the input device transmits data according to the wireless transmission manner, the receiver can be further utilized as an extended line of an external device. In this way, the input device can determine to transmit data according to a wired transmission manner or a wireless transmission manner according to user requirements, the power supply situation, or other considerations of the working environment.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An input device capable of transmitting data according to a wired transmission manner or a wireless transmission manner, comprising:
a receiver connected to a computer for transmitting a first data to the computer, comprising:
a first connector; and
a first wireless transceiving module; and
an input module, comprising:
a signal generating module for generating the first data;
a second connector electrically connected to the signal generating module, wherein the input module transmits the first data to the receiver through the first and the second connectors by utilizing the wired transmission manner when the second connector is electrically connected to the first connector; and
a second wireless transceiving module electrically connected to the signal generating module, wherein the input module transmits the first data to the receiver through the first and the second wireless transceiving modules by utilizing the wireless transmission manner when the second connector is not electrically connected to the first connector.

2. The input device of claim 1, wherein the input module further comprises:
a rechargeable battery for providing an operation voltage required by the input module, wherein the rechargeable battery is charged via power provided by the receiver when the second connector is electrically connected to the first connector.

3. The input device of claim 2, wherein the receiver is connected to the computer by utilizing a transmission line, and obtains power to be provided to the rechargeable battery from the computer through the transmission line.

4. The input device of claim 3, wherein the first connector and the second connector are universal serial bus (USB) connectors, and the transmission line is a USB transmission line.

5. The input device of claim 3, wherein the first connector and the second connector are FireWire connectors, and the transmission line is a FireWire transmission line.

6. The input device of claim 1, wherein the receiver further receives a second data outputted by an external device when the first connector is connected to the external device and the receiver receives the first data by utilizing the wireless transmission manner; the receiver further comprising:
a signal integrating module, electrically connected to the first connector and the first wireless transceiving module for integrating the first data and the second data to generate an integration data, and transmitting the integration data to the computer.

7. The input device of claim 1, wherein the input module is a mouse, a writing tablet, or a keyboard.
